(19) United States
(12) Patent Application Publication
(10) Pub. No.: US 2025/0149251 A1
(43) Pub. Date: May 8, 2025

(54) FILM CAPACITOR AND METHOD FOR PRODUCING FILM CAPACITOR

(71) Applicants: SHIZUKI ELECTRIC CO., INC., Nishinomiya-shi (JP); Murata Manufacturing Co., Ltd., Nagaokakyo-shi (JP)

(72) Inventors: Taishi MORIKAWA, Nishinomiya-shi (JP); Daiya NISHIJIMA, Nagaokakyo-shi (JP); Tomoki INAKURA, Nagaokakyo-shi (JP); Kenji HAGIYA, Nagaokakyo-shi (JP)

(21) Appl. No.: 19/005,100

(22) Filed: Dec. 30, 2024

Related U.S. Application Data
(63) Continuation of application No. PCT/JP2023/019730, filed on May 26, 2023.

(30) Foreign Application Priority Data
Jul. 7, 2022 (JP) 2022-109950

(51) Int. Cl. H01G 4/32; H01G 4/06; H01G 4/232

(52) U.S. Cl. CPC H01G 4/32; H01G 4/06; H01G 4/232

(57) ABSTRACT

A film capacitor including: a wound body comprising a pair of dielectric films each having a vapor-deposited metal on surface thereof, the pair of dielectric films being overlapped in a thickness direction of the wound body such that there is a gap between the pair of dielectric films, and the wound body having a pair of opposed ends; and a pair of end face electrodes at the opposed ends of the wound body, respectively, wherein the wound body has a shape in which a first dimension in a first direction is shorter than a second dimension in a second direction orthogonal to the first direction in a cross section in a third direction along an extending surface of each of the end face electrodes, and a ratio of a thickness of the gap to a thickness of the pair of dielectric films in the first direction is 0.003 to 0.029.

### CROSS REFERENCE TO RELATED APPLICATIONS

The present application is a continuation of International application No. PCT/JP2023/019730, filed May 26, 2023, which claims priority to Japanese Patent Application No. 2022-109950, filed Jul. 7, 2022, the entire contents of each of which are incorporated herein by reference.

### TECHNICAL FIELD

The present disclosure relates to a film capacitor and a method for producing a film capacitor.

### BACKGROUND ART

A film capacitor in which a dielectric film is wound is known. For example, Patent Document 1 describes a film capacitor including a main body in which a dielectric film, and a first electrode film and a second electrode film are wound multiple times, and having a gap between the dielectric film and the first electrode film or the second electrode film.
Patent Document 1: WO 2021/125006 A

### SUMMARY OF THE DISCLOSURE

The film capacitor of Patent Document 1 still has room for improvement in terms of reducing an anodic oxidation degree.

The present disclosure provides a film capacitor having a reduced anodic oxidation degree, and a method for producing the film capacitor.

A film capacitor according to one embodiment of the present disclosure is a film capacitor comprising: a wound body comprising a pair of dielectric films each having a vapor-deposited metal on surface thereof, the pair of dielectric films being overlapped in a thickness direction of the wound body such that there is a gap between the pair of dielectric films, and the wound body having a pair of opposed ends; and a pair of end face electrodes at the opposed ends of the wound body, respectively, wherein the wound body has a shape in which a first dimension in a first direction is shorter than a second dimension in a second direction orthogonal to the first direction in a cross section in a third direction along an extending surface of each of the end face electrodes, and a ratio of a thickness of the gap to a thickness of the pair of dielectric films in the first direction is 0.003 to 0.029.

A method according to one embodiment of the present disclosure is a method for producing a film capacitor, the method comprising: forming a wound body by winding a pair of dielectric films each having a vapor-deposited metal on a surface such that the dielectric films overlap each other in a thickness direction; pressing the wound body by controlling a press pressure within a predetermined range such that a ratio of a thickness of a gap between the pair of dielectric films to a thickness of the pair of dielectric films is 0.003 to 0.029; and forming end face electrodes on opposed ends of the wound body.

According to the present disclosure, it is possible to provide a film capacitor having a reduced anodic oxidation degree.

### BRIEF DESCRIPTION OF THE DRAWINGS

FIG. 1 is a perspective view illustrating a film capacitor according to a first embodiment of the present disclosure.

FIG. 2 is a perspective view illustrating a wound body in which a protective winding is omitted.

FIG. 3 is a diagram schematically illustrating a cross section of the wound body of FIG. 2.

FIG. 4 is a flowchart illustrating a method for producing the film capacitor according to the first embodiment of the present disclosure.

FIG. 5 is a schematic diagram illustrating a pair of dielectric films of the film capacitor of FIG. 1.

FIG. 6 is a schematic perspective view illustrating a state in which the dielectric films of FIG. 5 are wound.

FIG. 7 is a schematic cross-sectional view illustrating a step of pressing the wound body of the dielectric films of FIG. 6.

FIG. 8 is a schematic cross-sectional view illustrating a step of pressing the wound body of the dielectric films of FIG. 6.

FIG. 9 is a table showing measurement results of capacitance loss and an anodic oxidation degree.

FIG. 10 is a schematic view for explaining anodic oxidation of the film capacitor.

### DETAILED DESCRIPTION

### Circumstances Leading to the Present Disclosure

In the film capacitor described in Patent Document 1, it has been proposed that in a cross section perpendicular to a winding axis of a wound body, a diameter of an effective portion is made larger than a diameter of a metallikon electrode to reduce a volume ratio of the metallikon electrode, thereby achieving size reduction and high capacity of the film capacitor. In the film capacitor of Patent Document 1, a gas such as air remaining in a main body obtained by winding a dielectric film, and a first electrode film and a second electrode film is expanded to form a gap between the dielectric films, thereby increasing the diameter of the effective portion.

On the other hand, in a film capacitor in which a dielectric film is stacked or wound, when a voltage is applied, an electrode film provided on the film may react with moisture, ionic impurities, or the like contained in the film, thereby causing anodic oxidation on a surface of the electrode film.

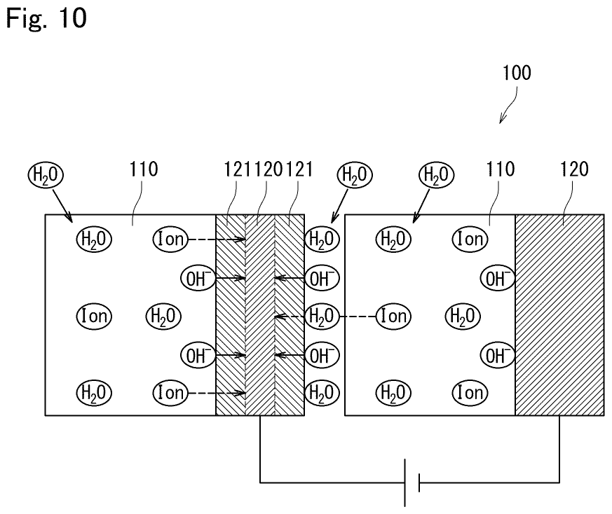

FIG. 10 is a schematic diagram for explaining anodic oxidation in a film capacitor. As illustrated in FIG. 10, the anodic oxidation is a phenomenon in which moisture (H₂O), ionic impurities (Ion), and the like contained in a dielectric film 110 react with an electrode film 120 formed of aluminum or the like, and an oxide film 121 is formed on the surface. When the anodic oxidation occurs, there is a problem that an effective electrode area of the electrode film 120 provided on the dielectric film 110 decreases, and the capacity decrease or ESR of the film capacitor increases. In order to reduce the anodic oxidation, it has been studied to provide a gap between the dielectric films 110.

The present inventors have found that it is important to appropriately control the size of a gap because when the gap between the dielectric films is too large, the capacitance of the film capacitor becomes smaller than a design value.

In the film capacitor described in Patent Document 1, it is difficult to control a size of the gap since the gap is formed by expanding a gas such as air remaining in the film. For this reason, there is a problem that the gap becomes larger than a desired size, and the capacitance of the film capacitor decreases.

Therefore, the present inventors have studied an appropriate thickness of the gap, studied a film capacitor capable of suppressing a decrease in capacitance while reducing the anodic oxidation degree, and reached the following disclosure.

Hereinafter, a first embodiment according to the present disclosure will be described with reference to the drawings. Furthermore, in each drawing, each element is exaggerated in order to facilitate the description.

### First Embodiment

### Overall Configuration

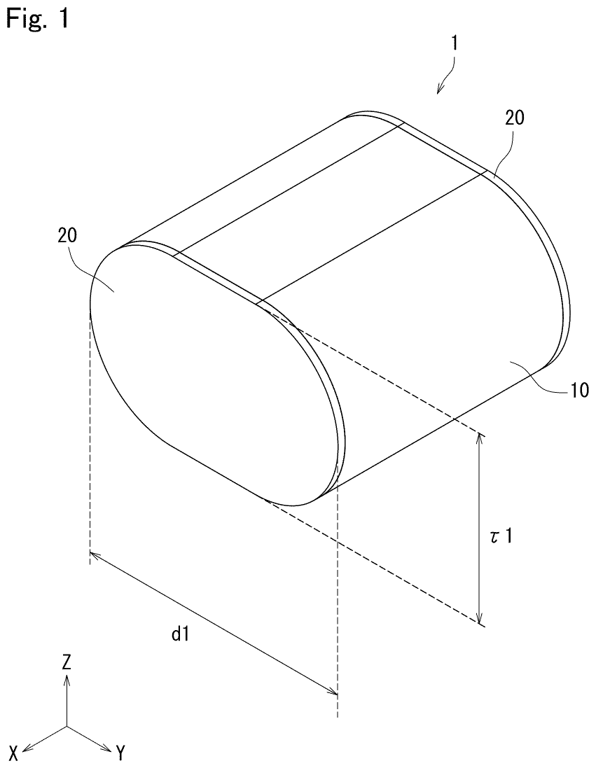

FIG. 1 is a perspective view illustrating a film capacitor according to a first embodiment of the present disclosure. Note that X, Y, and Z directions in the drawing respectively indicate a lateral direction, a longitudinal direction, and a height direction of a film capacitor 1.

As illustrated in FIG. 1, the film capacitor 1 includes a wound body 10 of a pair of dielectric films, and a pair of end face electrodes 20 provided at both ends of the wound body 10.

The wound body 10 is formed by stacking the pair of dielectric films each having a vapor deposited metal electrode provided on a surface thereof in a thickness direction, winding the dielectric films, and pressing the dielectric films into a flat shape. Note that the wound body 10 may be formed by stacking and pressing a plurality of the dielectric films.

The wound body 10 has a shape in which a dimension τ1 in the first direction (Z direction) is shorter than a dimension d1 in the second direction (Y direction) in a cross section in a direction along an extending surface (YZ plane) of the end face electrode 20. In other words, the wound body 10 is provided in a columnar shape having an oval cross section.

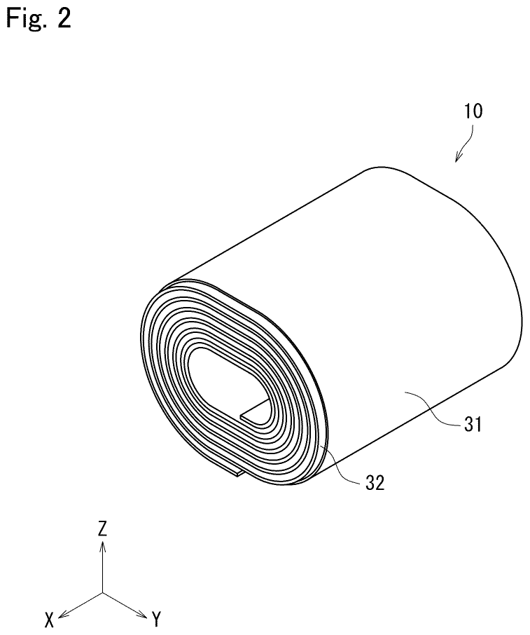

FIG. 2 is a perspective view illustrating the wound body in which a protective winding is omitted. In the present embodiment, a protective winding is provided on the surface of the wound body 10 in order to protect the dielectric film. As illustrated in FIG. 2, the wound body 10 is formed by winding a pair of dielectric films 31 and 32 in an overlapping manner in a thickness direction. More specifically, after one dielectric film 31 and the other dielectric film 32 are overlapped, the pair of dielectric films 31 and 32 are wound and pressed into a flat shape, thereby forming the wound body 10 having an oval cross section.

As the dielectric film, for example, a plastic film containing a thermoplastic resin such as polyethylene terephthalate, polypropylene, polyphenylene sulfide, or polyethylene naphthalate, or a plastic film containing a thermosetting resin such as a cured product obtained by reacting a hydroxyl group (OH group) of the first organic material with an isocyanate group (NCO group) of the second organic material can be used. As the vapor deposited metal electrode provided on the surface of the dielectric film, for example, a metal such as aluminum or zinc can be used.

The end face electrode 20 can be formed by, for example, spraying metal such as zinc on both ends of the wound body 10.

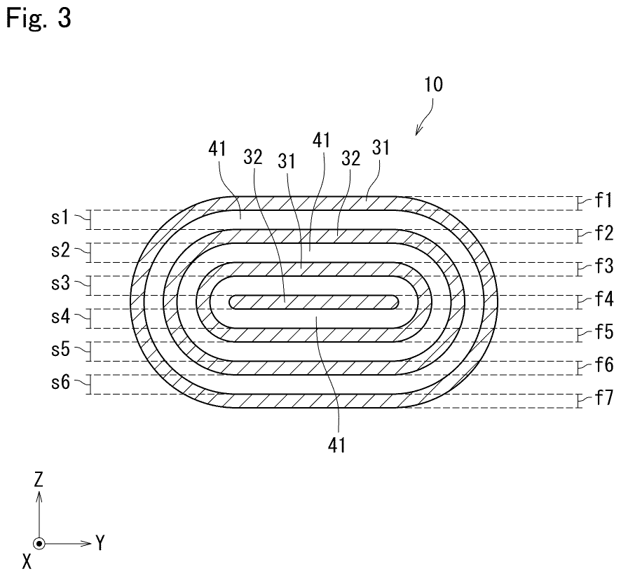

FIG. 3 is a diagram schematically illustrating a cross section of the wound body of FIG. 2. As illustrated in FIG. 3, a gap 41 is provided between the pair of dielectric films 31 and 32. For example, the gap 41 can be formed by overlapping and winding a pair of the dielectric films 31 so as to include an air layer between the dielectric film 32 and the dielectric film 31. Since the gap 41 is provided between the dielectric films 31 and 32, stress when an external force is applied to the wound body 10 can be reduced, and anodic oxidation of the vapor deposited metal electrodes provided on the surfaces of the dielectric films 31 and 32 can be suppressed.

In the first direction (Z direction), a ratio of a thickness of the gap in the height direction of the wound body 10 to a thickness of the dielectric films 31 and 32 is 0.003 to 0.029.

The thicknesses of the dielectric films 31 and 32 indicate the sum of thicknesses f1 to f7 of the stacked dielectric films 31 and 32 in the first direction (Z direction) of the wound body 10. Furthermore, the thickness of the gap 41 in the height direction (Z direction) of the wound body 10 indicates the sum of thicknesses s1 to s6 of the gap 41 in the first direction. That is, the ratio of the thickness of the gap to the thickness of the dielectric films 31 and 32 indicates a ratio of the sum of the thicknesses s1 to s6 of the gap 41 to the sum of the thicknesses f1 to f7 of the dielectric films 31 and 32. In other words, the size of the gap 41 is set such that the sum of the thicknesses s1 to s6 of the gap 41 is 0.003 to 0.029 with respect to the sum of the thicknesses f1 to f7 of the dielectric films 31 and 32.

Note that the gap 41 does not necessarily have to have a uniform thickness, and there may be a portion where the dielectric films 31 and 32 are in contact with each other.

### Producing Method

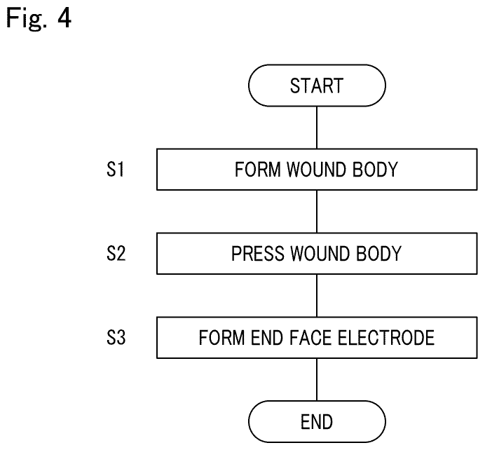

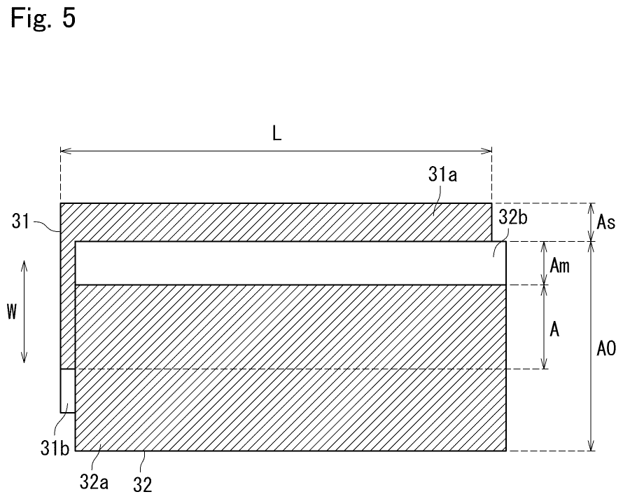

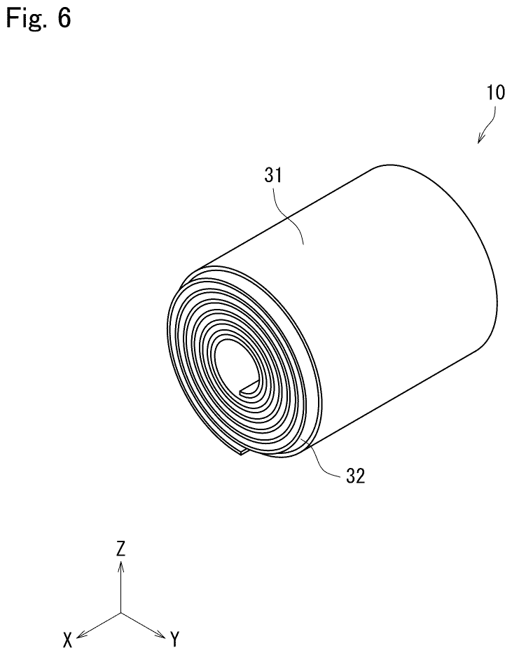

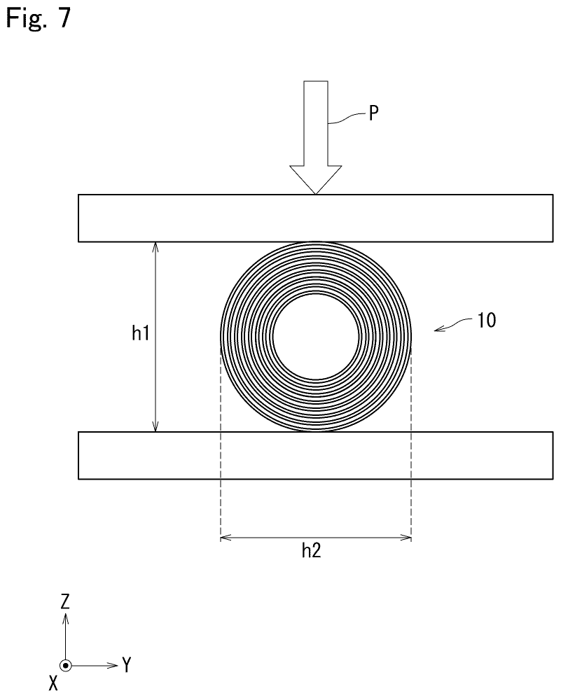

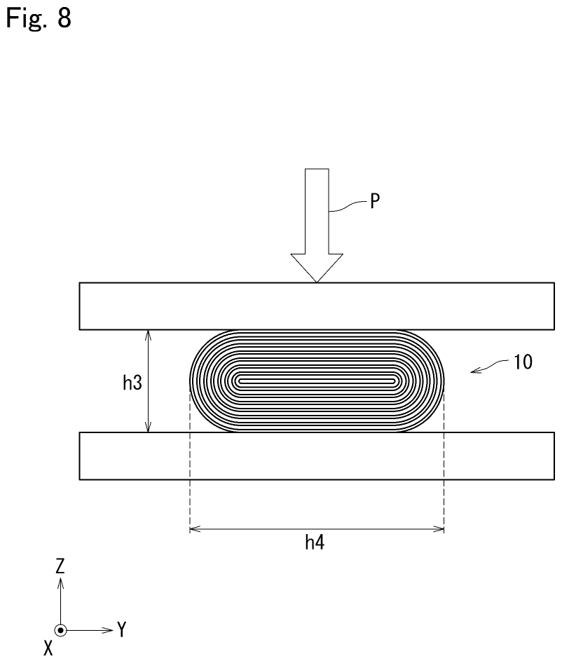

FIG. 4 is a flowchart illustrating the method for producing the film capacitor according to the first embodiment of the present disclosure. FIG. 5 is a schematic diagram illustrating the pair of dielectric films of the film capacitor in FIG. 1. FIG. 6 is a schematic perspective view illustrating a state in which the dielectric films of FIG. 5 are wound. FIG. 7 is a schematic cross-sectional view illustrating a step of pressing the wound body of the dielectric films of FIG. 6. FIG. 8 is a schematic cross-sectional view illustrating a step of pressing the wound body of the dielectric films of FIG. 6. A method for producing the film capacitor 1 will be described with reference to FIGS. 4 to 8.

In step S1, the wound body 10 is formed. In the formation of the wound body 10, first, as illustrated in FIG. 5, the pair of dielectric films 31 and 32 with metal vapor-deposited on the surfaces is stacked in the thickness direction. The dielectric films 31 and 32 are films in which vapor deposited metal electrodes 31a and 32a are provided on surfaces of strip-shaped dielectric films having a length L. The vapor deposited metal electrodes 31a and 32a are provided on the surfaces of the dielectric films 31 and 32 except insulating margins 31b and 32b. Furthermore, the vapor deposited metal electrodes 31a and 32a may be provided with pattern margins (not illustrated) on which no metal is vapor-deposited.

As illustrated in FIG. 5, the pair of dielectric films 31 and 32 is stacked so as to be shifted by a length As in a width direction W. By stacking the dielectric films 31 and 32 in this way, occurrence of a short circuit between the vapor deposited metal electrodes 31a and 32a and the end face electrode 20 can be suppressed after the end face electrode 20 is formed in a later step.

Next, when the overlapped pair of dielectric films 31 and 32 is wound, as illustrated in FIG. 6, the wound body 10 in a columnar shape is obtained. As illustrated in FIG. 7, in the wound body 10 formed in step S1, a dimension h1 in the first direction (Z direction) and a dimension h2 in the second direction (Y direction) in a cross section (YZ plane) perpendicular to a winding axis are substantially the same, and the wound body 10 has a columnar shape having a substantially circular cross section.

In step S2, the wound body 10 is pressed. As illustrated in FIGS. 7 and 8, a side surface of the columnar-shaped wound body 10 is pressed to form the wound body 10 in a flat shape. For example, it is possible to form the flat-shaped wound body 10 by disposing the columnar-shaped wound body 10 in a press device and applying pressure in a direction of an arrow P. By adjusting a press pressure, the thickness of the gap 41 between the dielectric films 31 and 32 can be adjusted. More specifically, the larger the press pressure, the smaller the thickness of the gap 41. By pressing the wound body 10 in step S2, as illustrated in FIG. 8, a dimension h3 in the first direction in a cross section (YZ plane) perpendicular to the winding axis becomes relatively smaller than a dimension h4 in the second direction.

In step S3, the end face electrode 20 is formed on the pressed wound body to complete the film capacitor 1 illustrated in FIG. 1. The end face electrodes 20 can be formed by spraying metal such as zinc on both ends of the wound body 10.

### EXAMPLES

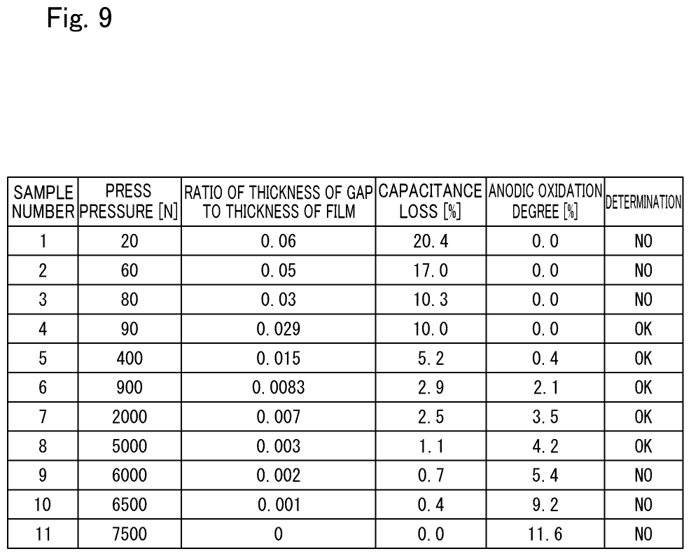

In the film capacitor described in the first embodiment, the thickness of the gap 41 was changed by changing the press pressure in the step of pressing the wound body 10 (step S2 in FIG. 4), and the deviation from the design capacitance value of the film capacitor 1 and the anodic oxidation degree were measured. Specific results are as shown in FIG. 9.

### Film Capacitor

In Examples, the deviation from the design capacitance value and the anodic oxidation degree were measured using a film capacitor in which the ratio of the thickness of the gap 41 to the thickness of the dielectric films 31 and 32 was changed from 0 to 0.06 by changing the press pressure in 11 steps.

### Thickness of Gap

The ratio of the thickness of the gap to the thickness of the dielectric film of each film capacitor was calculated by the following method.

First, the height τ1 (see FIG. 1) of the film capacitor in the first direction is measured. Next, the film capacitor is disassembled to obtain the number of windings of the dielectric film. The obtained number of windings is denoted by T_{film}, and a film thickness of the dielectric film is denoted by d_{film}. Note that the film thickness of the dielectric film also includes a thickness of the vapor deposited metal electrode. The number of windings of pre-winding and protective winding other than the dielectric film in the film capacitor is also obtained in the same manner. The pre-winding is a portion serving as a core when the dielectric film is wound, and the protective winding is a portion wound around the outer periphery to protect the dielectric film and the vapor deposited metal electrode. The number of windings of the first winding is denoted by Tᵢₙ, the film thickness is denoted by din, the number of windings of the protective winding is denoted by Tₒᵤₜ, and the film thickness is denoted by dₒᵤₜ.

A height τ0 of the film capacitor in the first direction when it is assumed that no gap is provided is calculated by Formula (1).

$$τ 0 = {d}_{i n} \times {T}_{i n} \times 2 + {d}_{out} \times {T}_{out} \times 2 + {T}_{film} \times {d}_{film} \times 4 \qquad ( 1 )$$

Note that, since two layers of the pre-winding and the protective winding are included in the first direction when the pre-winding and the protective winding are wound once, the thickness in the first direction was calculated as “number of windings×film thickness×2”. The dielectric film includes four layers in the first direction in one winding since two sheets are wound as a pair. So, the thickness in the first direction was calculated as “number of windings×film thickness×4”.

By subtracting τ0 from τ1, that is, by Formula (2), a thickness D of the gap included in the film capacitor can be calculated.

$$D = τ1 - τ0 \qquad ( 2 )$$

A thickness dₐᵢᵣ of the gap per one dielectric film is calculated by Formula (3).

$${d}_{a i r} = D / ( 4 * {T}_{film} ) \qquad ( 3 )$$

Therefore, a ratio R of the thickness of the gap to the thickness of the dielectric film is calculated by Formula (4).

$$R = {d}_{a i r} / {d}_{film} \qquad ( 4 )$$

### Design Capacitance Value

The design capacitance value of the film capacitor can be calculated as follows.

The film capacitor is disassembled to take out the dielectric film. A film width A0, an effective electrode width A, an insulation margin width Am, and the length L of the dielectric film are measured (see FIG. 5). The effective electrode width A indicates a width of the vapor deposited metal electrode actually acting as a capacitor. A dielectric constant of vacuum is denoted by co, a relative dielectric constant of the dielectric film is denoted by ε_{film}, and an effective electrode area ratio is denoted by N. The effective electrode area ratio N indicates a ratio of an area of a portion obtained by excluding the pattern margin and the like from an area of the effective electrode calculated by “effective electrode width A×length L of dielectric film”. Specifically, the effective electrode area ratio N can be calculated by “N=(L×A−Sp)/(L×A)”. Note that Sp represents an area where metal such as a pattern margin is not vapor-deposited. Furthermore, the effective electrode width A can be calculated from “A=A0−2Am−As”. The design capacitance value C0 of the film capacitor can be calculated by Formula (5).

$$C 0 = {ε}_{0} {ε}_{film} \times L \times A \times N / {d}_{film} \qquad ( 5 )$$

### Capacitance Loss with Respect to Design Capacitance Value

The capacitance loss ΔC with respect to the design capacitance value C0 of each film capacitor can be calculated by Formula (6) using the actual measurement capacitance value C1 and the design capacitance value C0 of each film capacitor.

$$Δ C = ( C 0 - C 1 ) / C 0 \times 100 \qquad ( 6 )$$

### Measurement of Anodic Oxidation Degree

A high-temperature and high-humidity test was performed on the film capacitor in which the thickness of the gap 41 was adjusted by each press pressure, and the anodic oxidation degree after the high-temperature and high-humidity test was measured. The anodic oxidation degree was measured by obtaining a ratio of an area of white discoloration of the vapor deposited metal electrodes 31a and 32a of the dielectric films 31 and 32.

In the high-temperature and high-humidity test, a voltage of 500 V was applied for 1000 hours in an environment of a temperature of 85° C. and a humidity of 85% RH.

After the high-temperature and high-humidity test, the film capacitor was disassembled, and the ratio of the area discolored to white by anodic oxidation in the effective electrode area was calculated. Note that a portion discolored to white by anodic oxidation was visually determined. Note that a difference between a discolored portion and a non-discolored portion is visually clear, and there is no substantial difference in a result of an area ratio as compared with the case of using an image processing technology.

An effective electrode area Aₐₗₗ was calculated from “length L of dielectric film×effective electrode width A”. When an area of the portion whitened by anodic oxidation is Aₒₓ, an anodic oxidation degree O can be calculated by Formula (7).

$$O = {A}_{o x} / {A}_{all} \times 100 \qquad ( 7 )$$

### Measurement Results

FIG. 9 is a table showing measurement results of the capacitance loss and the anodic oxidation degree. With reference to FIG. 9, a preferable range of the thickness of the gap 41 will be examined.

In a case where the ratio R of the thickness of the gap to the thickness of the dielectric film is 0.029 or less, the capacitance loss ΔC indicating how much the actual measurement capacitance value C1 of the film capacitor is decreased with respect to the design capacitance value C0 is 10% or less. This is because the capacitance loss ΔC increases as the thickness of the gap between the dielectric films increases. In the product standards of the film capacitor, since the capacitance loss ΔC with respect to the design capacitance value C0 is required to be 10% or less, the ratio R of the thickness of the gap is desirably 0.029 or less.

Furthermore, in a case where the ratio R of the thickness of the gap to the thickness of the dielectric film is 0.003 or more, the anodic oxidation degree can be suppressed to 5% or less. When the anodic oxidation degree increases, equivalent series resistance (ESR) when a voltage is applied to the film capacitor increases. In the product standards of the film capacitor, the rate of increase in ESR is required to be 50% or less, and when the anodic oxidation degree is 5% or less, the product standards can be more reliably satisfied. Therefore, the ratio R of the thickness of the gap is desirably 0.003 or more. Note that a rate of increase in ESR is an index indicating how much the ESR has increased before and after the high-temperature and high-humidity test, for example.

From the above results, the ratio R of the thickness of the gap to the thickness of the dielectric film is preferably 0.003 to 0.029.

### Effects

According to the above-described embodiment, the following effects can be obtained.

The film capacitor 1 includes the wound body 10 and the pair of end face electrodes 20. The wound body 10 is obtained by winding the pair of dielectric films 31 and 32 overlapped in the thickness direction with metal vapor-deposited on the surface. The end face electrodes 20 are provided at both ends of the wound body 10. The gap 41 is provided between the pair of dielectric films 31 and 32. The wound body 10 has a shape in which the dimension t1 in the first direction (Z direction) is shorter than the dimension d1 in the second direction (Y direction) orthogonal to the first direction in a cross section in a direction along an extending surface (YZ plane) of each of the end face electrodes 20. The ratio of the thickness of the gap 41 in the height direction of the wound body 10 to the thickness of the dielectric films 31 and 32 in the first direction is 0.003 to 0.029.

With such a configuration, anodic oxidation of the film capacitor 1 can be suppressed. By providing the gap 41 between the dielectric films 31 and 32, anodic oxidation of vapor deposited metal electrodes 31a and 32a can be prevented. On the other hand, by setting the ratio of the thickness of the gap 41 to 0.003 to 0.029, the capacitance loss of the film capacitor 1 can be suppressed. Therefore, it is possible to provide the film capacitor 1 in which anodic oxidation hardly occurs and capacitance loss is small.

Furthermore, when the design capacitance value of the film capacitor 1 is denoted by C0, and the actual measurement capacitance value is denoted by C1, (C0-C1)/C0×100 is 10% or less.

With such a configuration, the film capacitor 1 having a small capacitance loss can be provided.

A method for producing the film capacitor 1 includes a step of forming a wound body, a step of pressing the wound body, and a step of forming an end face electrode. The step of forming the wound body includes winding the pair of dielectric films 31 and 32 with metal vapor-deposited on their surfaces so as to overlap each other in the thickness direction. The step of pressing the wound body includes controlling the thickness of the gap 41 provided between the pair of dielectric films 31 and 32 by controlling the press pressure to a predetermined range.

With such a configuration, it is possible to provide the film capacitor 1 in which the gap having an appropriate thickness is provided.

### Outline of Embodiment

(1) A film capacitor including: a wound body comprising a pair of dielectric films each having a vapor-deposited metal on surface thereof, the pair of dielectric films being overlapped in a thickness direction of the wound body such that there is a gap between the pair of dielectric films, and the wound body having a pair of opposed ends; and a pair of end face electrodes at the opposed ends of the wound body, respectively, wherein the wound body has a shape in which a first dimension in a first direction is shorter than a second dimension in a second direction orthogonal to the first direction in a cross section in a third direction along an extending surface of each of the end face electrodes, and a ratio of a thickness of the gap to a thickness of the pair of dielectric films in the first direction is 0.003 to 0.029.

(2) In the film capacitor according to (1), wherein when a design capacitance value of the film capacitor is denoted by C0, and an actual measurement capacitance value is denoted by C1, (C0-C1)/C0×100 is 10% or less.

(3) A method for producing a film capacitor, the method including: forming a wound body by winding a pair of dielectric films each having a vapor-deposited metal on a surface such that the dielectric films overlap each other in a thickness direction; pressing the wound body by controlling a press pressure within a predetermined range such that a ratio of a thickness of a gap between the pair of dielectric films to a thickness of the pair of dielectric films is 0.003 to 0.029; and forming end face electrodes on opposed ends of the wound body.

The present disclosure is useful for film capacitors used in various electronic devices, electric devices, industrial devices, vehicle devices, and the like.

### REFERENCE SIGNS LIST

1 film capacitor
10 wound body
20 end face electrode
31, 32 dielectric film
31a, 32a vapor deposited metal electrode
31b, 32b insulating margin
41 gap

1. A film capacitor comprising:
a wound body comprising a pair of dielectric films each having a vapor-deposited metal on surface thereof, the pair of dielectric films being overlapped in a thickness direction of the wound body such that there is a gap between the pair of dielectric films, and the wound body having a pair of opposed ends; and
a pair of end face electrodes at the opposed ends of the wound body, respectively,
wherein
the wound body has a shape in which a first dimension in a first direction is shorter than a second dimension in a second direction orthogonal to the first direction in a cross section in a third direction along an extending surface of each of the end face electrodes, and a ratio of a thickness of the gap to a thickness of the pair of dielectric films in the first direction is 0.003 to 0.029.

2. The film capacitor according to claim 1, wherein the ratio of the thickness of the gap to the thickness of the pair of dielectric films in the first direction is 0.015 to 0.029.

3. The film capacitor according to claim 2, wherein, when a design capacitance value of the film capacitor is denoted by C0, and an actual measurement capacitance value is denoted by C1, (C0-C1)/C0×100 is 0.5% or less.

4. The film capacitor according to claim 1, wherein, when a design capacitance value of the film capacitor is denoted by C0, and an actual measurement capacitance value is denoted by C1, (C0-C1)/C0×100 is 10% or less.

5. A method for producing a film capacitor, the method comprising:
forming a wound body by winding a pair of dielectric films each having a vapor-deposited metal on a surface such that the dielectric films overlap each other in a thickness direction;
pressing the wound body by controlling a press pressure within a predetermined range such that a ratio of a thickness of a gap between the pair of dielectric films to a thickness of the pair of dielectric films is 0.003 to 0.029; and
forming end face electrodes on opposed ends of the wound body.

6. The method for producing a film capacitor according to claim 5, wherein the wound body is pressed into a shape in which a first dimension in a first direction is shorter than a second dimension in a second direction orthogonal to the first direction in a cross section in a third direction along an extending surface of each of the end face electrodes.

7. The method for producing a film capacitor according to claim 5, wherein the pressing pressure during the pressing of the would body is controlled such that the ratio of the thickness of the gap to the thickness of the pair of dielectric films is 0.015 to 0.029.

8. The method for producing a film capacitor according to claim 7, wherein the wound body is pressed into a shape such that, when a design capacitance value of the film capacitor is denoted by C0, and an actual measurement capacitance value is denoted by C1, (C0-C1)/C0×100 is 0.5% or less.

9. The method for producing a film capacitor according to claim 5, wherein the wound body is pressed into a shape such that, when a design capacitance value of the film capacitor is denoted by C0, and an actual measurement capacitance value is denoted by C1, (C0-C1)/C0×100 is 10% or less.
